(19) United States
(12) Patent Application Publication
(10) Pub. No.: US 2009/0049097 A1
(43) Pub. Date: Feb. 19, 2009

(54) Method and Systems for Self-Service Programming of Content and Advertising in Digital Out-Of-Home Networks

(76) Inventors: Alexander D. Nocifera, Manahttan Beach, CA (US); Claude Ciocan, Placentia, CA (US); Ali Diab, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/030,745

(22) Filed: Feb. 13, 2008

Related U.S. Application Data
(60) Provisional application No. 60/889,886, filed on Feb. 14, 2007.

(51) Int. Cl. G06F 17/30; G06F 15/16

(52) U.S. Cl. 707/104.1; 709/218; 709/224; 726/28; 707/E17.044

(57) ABSTRACT

A media and content distribution system comprising a global scheduling system (GSS) configured to collect data and content, an Internet network, and one or more Regional Content Delivery Systems (RCDSs) is disclosed. The one or more RCDSs are configured to receive data and content and communicate with the GSS via the Internet network. The one or more RCDSs further comprise a regional content distributor/local data aggregator configured to receive data and content from the GSS, a cellular or wireless network, one or more remote display units (RDU) configured to display the data and content, and a data unit configured to acquire information related to activity at the one or more RDUs. The data unit is in communication with at least one of the one or more RDUs. The one or more RDUs are in communication with the regional content distributor/local data aggregator via the cellular or wireless network.

### CROSS-REFERENCE TO RELATED APPLICATIONS

The present patent application claims priority benefit of U.S. Provisional Application No. 60/889,886, filed Feb. 14, 2007, titled “METHODS AND SYSTEMS FOR SELF-SERVICE PROGRAMMING OF CONTENT AND ADVERTISING IN DIGITAL OUT-OF-HOME NETWORKS,” the contents of which is hereby incorporated by reference in its entirety.

### BACKGROUND OF THE INVENTION

1. Field of the Invention

The present invention generally relates to communication networks, and in particular, to systems and methods for media content distribution for digital signage networks and applications. More particularly, this invention relates to systems and methods for programming of content and advertising over digital networks.

2. Description of the Related Art

Digital and electronic signs are a dynamic media solution to help marketers target messages to a specific audience. Networked digital signage includes what some in the industry have termed narrowcasting in public spaces. This form of media communication allows advertising and other information to be delivered to narrow demographic groups at specific times in public venues. Examples of narrowcasting in public spaces include delivering pricing and promotional messages to shoppers in department stores or supermarkets, delivering appropriate advertising and news to commuters at airports, in train stations, on buses, in elevators, or highlighting special offers to customers at retail settings. These and other examples of digital signage can be characterized generally into segments: point of purchase, visual merchandising, and display of content, any of which can be interactive.

One of the biggest problems with current digital signage networks is the investment of both financial resources and time to install the network infrastructure to support the underlying product. Most current digital signage technologies require the establishment of a LAN-based network. Setting up such a LAN-based network requires extensive capital for both the installation and maintenance of the network itself (cabling, routing, etc.) and the supporting server-based infrastructure. Even with the needed capital, many prime digital signage locations are not conducive to the installation of such items. Even wireless networks today mostly consist of 802.11 Networks, which still require the installation and maintenance of a LAN-based infrastructure to support the 802.11 Network.

It is also known to provide video advertising through out-of-home video display units. Video remains one of the most popular advertising medium in use today. In recent years, retailers and public space managers have brought in more video display systems for various advertising use. For example, retailers can use video displays to present current product offerings or sale information, while the public spaces can sell play or air time on such video displays to local or national advertisers. One of the common goals is to expose large numbers of consumers to the presentation of the advertisement and media content. While video is one of the most effective mediums because of its eye-catching, full color, high-resolution and full motion capability, there remain significant drawbacks in selecting this medium for advertising applications. Among other disadvantages, the production of video content can be expensive, and the production and distribution of new video material to one or more display units usually requires a high level of physical or manual intervention. Existing systems can distribute content to video display units in a variety of ways but with certain limitations. For example, a pre-recorded video loop can be played continuously on selected units and receive updated content via portable recording media such as a digital video disk (DVD). As new video loops are produced by, for example, an advertisement production agency, multiple copies of the portable media have to be manufactured and physically distributed to each operator of video display units at selected locations for playback. Alternatively, new material can be distributed or broadcast all at once although all displays can have to present the same material simultaneously and in the same manner. The addition of a single piece of new content to a presentation loop could furthermore require re-editing of the display media. It is often impractical and difficult to edit or re-sequence digital content once deployed to video display units. In the case of current systems where digital content is distributed and scheduled for viewing at any number of points of play, the administrative overhead to manually intervene and edit previously unscheduled content is time consuming and costly. An improved solution is needed to create, schedule and distribute content, including advertising, over digital networks.

### SUMMARY OF THE INVENTION

In accordance with various aspects of the present invention, a media and content distribution system and method are provided, wherein specific media and content, including advertising material, real-time traffic, news, sports, weather, and financial stock and/or other information is delivered to locally distributed display panels, such as plasma and LCD screens, positioned in viewing areas. In addition, an exemplary media and content distribution system can include a scheduling and rotating capability that enables multiple media files to display at multiple locations based on each individual display requirement for advertising, training, entertainment, and other purposes.

In accordance with an exemplary embodiment, a media and content distribution system comprises a Global Scheduling System (GSS) and a Regional Content Delivery System (RCDS) configured to communicate through a communications network such as the Internet. Content and media can suitably be delivered from the Regional Content Delivery System to a Remote Display Unit (RDU). The Remote Display Unit can suitably “poll” the Regional Content Delivery System to receive data and information, and then proceed to store the data and information locally to suitably reduce network utilization. Accordingly, selected data, content and information can be provided at each Remote Display Unit depending on the requests or intentions of advertisers, data providers and/or local remote display users and viewers.

In another embodiment, a media and content distribution system comprising a GSS, an Internet network, and one or more RCDSs is disclosed. The GSS is configured to collect data and content and further comprises a global data aggregator configured to obtain data and content from data sources, a data repository to store data and content, a web portal to manage and schedule data and content, and a content delivery system to distribute the scheduled data and content. The one or more RCDSs are configured to receive data and content and communicate with the GSS via the Internet network. The one or more RCDSs further comprise a regional content distributor/local data aggregator configured to receive data and content, a cellular or wireless network, one or more RDUs configured to display the data and content, and a data unit configured to acquire information related to activity at the one or more RDUs. The data unit is in communication with at least one of the one or more RDUs. The one or more RDUs are in communication with the regional content distributor/local data aggregator via the cellular or wireless network.

One aspect of the invention provides a method of acquiring information about activity related to RDUs. The method comprises determining whether data acquisition is available for RDUs and determining available data sources from which the RDUs can acquire data. The method further comprises selecting the appropriate data algorithm to process the data acquired from the available data sources, and obtaining the data about activity related to the RDUs in accordance with the selected data algorithm.

Another aspect of the invention provides digital media presentation systems having display units that receive video images as clips and other content in conjunction with scheduling information. The information received by the units can include the timing and/or sequence in which the video clips and other content should be presented on the display units. Furthermore, the video display units can be divided into a plurality of windows or advertising regions. Within selected regions of the display units, desired content and scheduling information can be provided. In some embodiments of the invention, the scheduling information for content in each window or advertising window can be timed independently, or alternatively, the scheduling of content for a particular display unit can be synchronized in a selected manner.

In another embodiment of the invention, content and scheduling information are provided by one or more servers within a global scheduling system to selected display units residing in one or more locations. Each location can contain one or more display units connected to a regional content delivery system, which in turn, are connected to the global scheduling system. The display units within a location can be optionally connected over a local area network, which can be addressed as a subnet of a larger network. Locations can include retail stores, food and dining establishments and other locations that are frequented by consumers.

The content and media systems provided in accordance with another aspect of the invention can comprise a self-service work station that allows an advertiser or other user to program content. The work station can be any computer capable of presenting a user interface or browser enabled device that allows a user to specify video information or other content to be displayed and provide scheduling information for each display unit. The video information or other content can be specified in multiple ways, such as graphics files, text to be displayed as a ticker, as an executable file or in any other suitable manner.

Other embodiments of the invention include, the server is an interconnection of servers and databases, including an interface server that manages interactions with human users, a media server that stores media and a database server that stores information about scheduling or displayed video. In a preferable embodiment, the server is located at a central location and connected over a wide area network to a local area network having a plurality of display units. The server can alternatively be connected to a plurality of display units over a local area network.

Another aspect of the invention relates to a series of one or more video display units adapted for displaying video information and other content according to a predetermined schedule established over a graphical user interface (GUI). The display unit has a screen, a processor and a storage medium for storing content and schedule information. The processor is programmed to display selected video clips in accordance with the desired schedule information created by a user. A preferable embodiment of the invention includes display units that are programmed to generate a log of assets or video clips displayed. Each display unit can periodically write its log file to a server, where the information can be used for billing or other analysis.

It shall be further understood this invention includes methods and systems for programming content and advertising that are particularly suitable for digital out-of-home networks (“DOHNs”). DOHNs can be defined as networks comprised of electronic displays, e.g. cathode ray televisions (“CRTs”), liquid crystal displays (“LCDs”) or plasma television panels (“PTPs”) that are deployed in public venues, such as coffee shops, concert halls, shopping malls, sports stadiums, university campuses, etc. The DOHNs provided in accordance with the invention can be used to display targeted content and advertising to consumers that are visiting locales throughout selected regions wherein these systems are deployed. The systems and methods provided herein are an improvement over the content and advertising solutions today that rely on displays that are programmed through a relatively time-intensive process by the administrator or owner of the DOHN (“DOHNadmin”). In a typical DOHN, the DOHNadmin receives advertising or content to be displayed on the DOHN from an advertiser or content creator (e.g. a film studio or local television station) in the form of a DVD or File Transfer Protocol (“FTP”) format. The DOHNadmin then compiles, edits and programs the content or advertising to be displayed on the DOHN through an administrator interface that controls all content on the DOHN. Instead, some of the solutions provided in accordance with the invention offers a way for advertisers and/or content creators to program their advertising or content directly, without the need for a DOHNadmin. This can be achieved through an Internet based interfaces. These and other aspects of the invention provide improved digital signage and DOHN systems that take advantage of rapidly-developing technologies for networking, scheduling, content management, and electronic displays. When integrated effectively, these technologies can deliver advertising that can be sold and managed alone or complement traditional signs in stores, in buildings, along highways, or in other public places. It shall be understood that the concepts of the invention can be applied to known digital signage and out-of-home advertising systems such as those described in published patent application US 2006/0059511 filed on Sep. 14, 2005 entitled System and Method for Media Content Distribution, which is incorporated by reference herein in its entirety.

Other goals and advantages of the invention will be further appreciated and understood when considered in conjunction with the following description and accompanying drawings. While the following description can contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### BRIEF DESCRIPTION OF THE DRAWINGS

These and other features will now be described with reference to the drawings summarized below. These drawings and the associated description are provided to illustrate one or more embodiments of the invention, and not to limit the scope of the invention.

FIGS. 1 and 1A illustrate diagrams of exemplary media content distribution systems in accordance with exemplary embodiments of the present invention.

FIGS. 2A and 2B illustrate logic diagrams of exemplary methods of RDU data transport in accordance with exemplary embodiments of the present invention.

FIG. 2C illustrates a logic diagram of an exemplary method of data acquisition and processing to modify displayed content in accordance with an exemplary embodiment of the present invention.

FIG. 2D illustrates a diagram of a data acquisition system in accordance with an exemplary embodiment of the present invention.

FIGS. 3 and 3A illustrate diagrams of an exemplary cellular/wireless network in accordance with exemplary embodiments of the present invention.

FIG. 4 illustrates an exemplary configuration of a screen layout for an RDU in accordance with an exemplary embodiment of the present invention.

FIG. 5 illustrates an exemplary screen image in accordance with an exemplary embodiment of the present invention.

FIG. 6 illustrates a sample advertising layout in accordance with an exemplary embodiment of the present invention.

FIG. 7 illustrates an overview of the level of control available to an advertiser user over a self-service advertising programming user interface that is accessible via a Web browser.

FIGS. 8-11 illustrate a set of screenshots for a user interface that provides targeted advertising to customers of business establishments within a geographical area.

### DETAILED DESCRIPTION OF THE PREFERRED EMBODIMENT

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein can be employed in practicing the invention. It is intended that the following claims define the scope of the invention and that methods and structures within the scope of these claims and their equivalents be covered thereby.

Several embodiments will be described herein in terms of various components and processing steps. It should be appreciated that such components and steps can be realized by any number of hardware and software components configured to perform the specified functions. For example, the embodiments of the present invention can employ various electronic control devices, visual display devices, input terminals and the like, which can carry out a variety of functions under the control of one or more control systems, microprocessors or other control devices. In addition, the embodiments of the present invention can be practiced in any number of communication contexts and the exemplary embodiments relating to systems and methods for media content distribution for digital signage networks and applications as described herein are merely a few of the exemplary applications for the invention. For example, the principles, features and methods discussed can be applied to any communications application.

In accordance with various aspects of the present invention, a media and content distribution system and method are provided, wherein specific media and content, including, without limitation, advertising material, real-time traffic, news, sports, weather, and financial stock and/or other like information is delivered via network technology to locally distributed display panels, such as, for example, plasma and LCD screens, positioned in viewing areas. In addition, a media and content distribution system can include a scheduling and rotating capability that enables multiple media files to display at multiple locations based on each individual display requirement for advertising, training, entertainment, and other purposes.

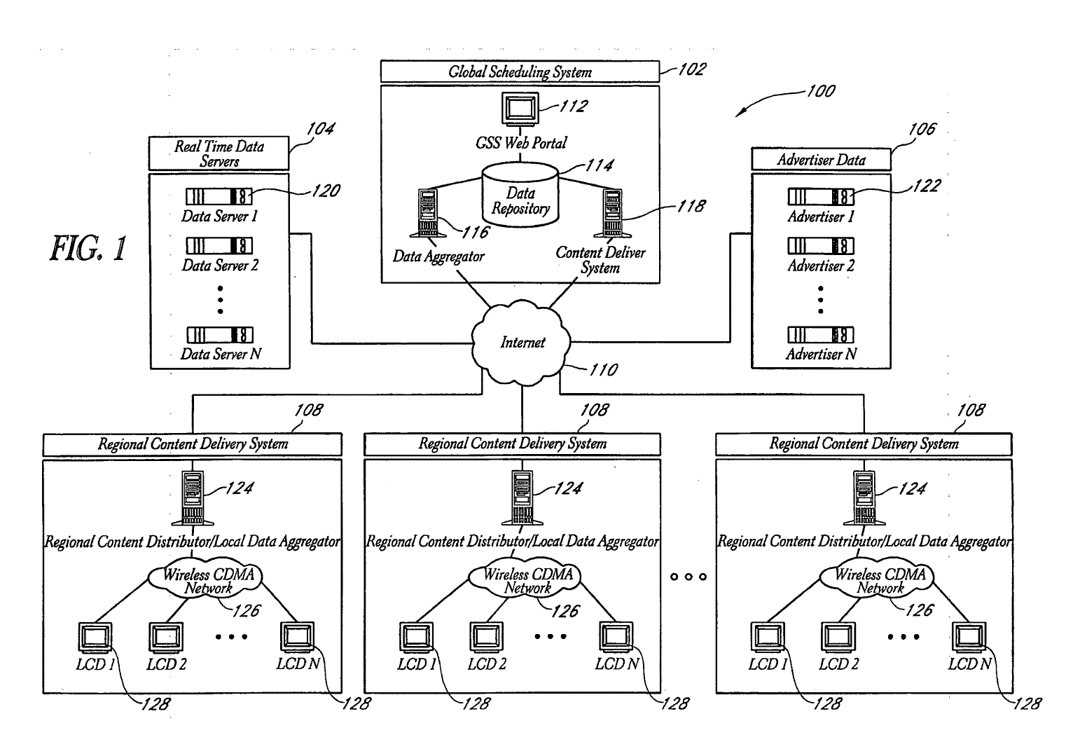

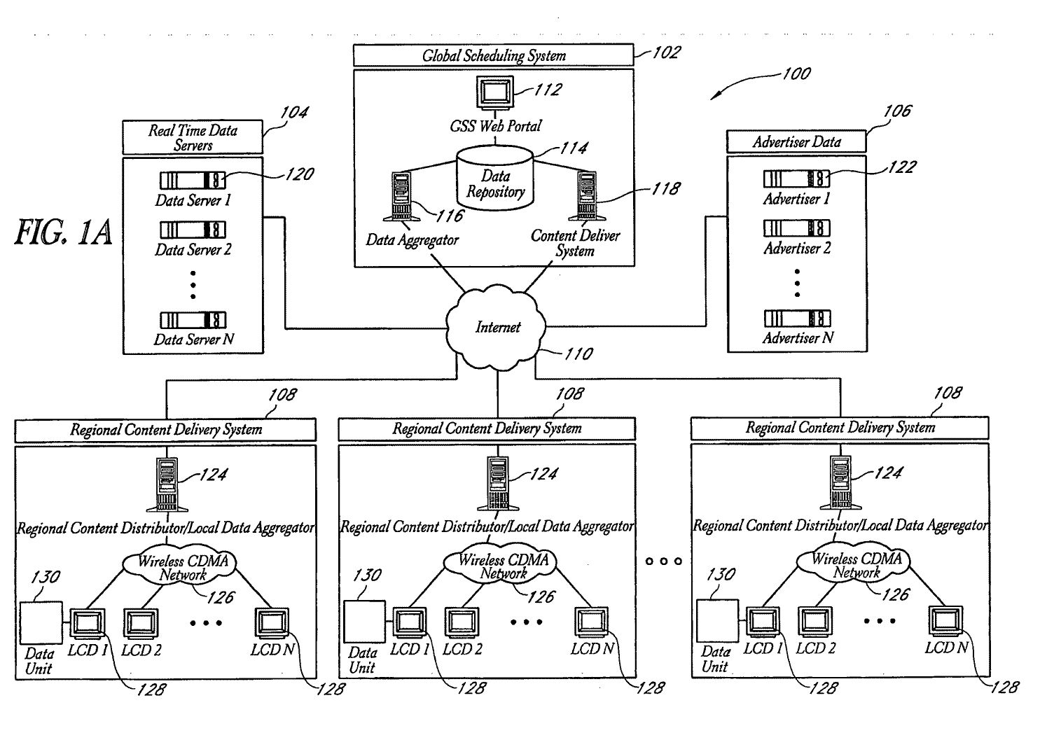

FIG. 1 illustrates an exemplary media and content distribution system 100, wherein the exemplary media and content distribution system 100 comprises a Global Scheduling System (GSS) 102, real-time data servers 104, advertiser data sources 106 and one or more Regional Content Delivery Systems (RCDSs) 108, any of which can be configured to communicate through a communications network such as the Internet network 110. Internet network 110 can comprise any network configuration that allows communication between the GSS 102, RCDSs 108, real-time data servers 104 and/or advertiser data 106.

The GSS 102 is configured to collect data and content and also to provide such data and content to the RCDSs 108. In accordance with an exemplary embodiment, the GSS 102 comprises a global data aggregator 116 to collect real-time data and graphical content from disparate systems, a data repository 114 to store the data and content, a web portal 112 to manage and schedule the data and content, and a content delivery system 118 to distribute the data and content as well as the scheduling information to the RCDSs 108.

With continued reference to FIG. 1, the global data aggregator 116 of the GSS 102 communicates with content providers, including real-time data providers, to obtain data and content. In one embodiment, the global data aggregator 116 can update the data repository 114 with the obtained data. In some embodiments, the global data aggregator 116 periodically updates the data repository 114 with the obtained data. Because the format of the data supplied by the content providers can vary, the global data aggregator 116 can be configured to normalize the various types of data and store the data in a common format. Such data and advertising content can be acquired from various sources, such as, without limitation, the real-time data servers 104 and/or the advertising data sources 106. The global data aggregator 116 can also gather and store the media files necessary to display the content.

The web portal 112 of the GSS 102 can enable users to add, manipulate, remove and/or otherwise manage data and content, for example, that is aggregated by the global data aggregator 116. As will be further discussed below, the web portal 112 can be further configured to authorize users to schedule media delivery to one or more remote display units (RDUs) 128. The web portal 112 allows content and data to be manipulated and rescheduled easily. In certain embodiments, the web portal 112 enables users to retain a complete log of historical data by maintaining changes to the data and content in the data repository 114.

The data repository 114 of the GSS 102, in addition to storing digital content, can be configured to serve as a scheduling database. The data repository 114 can store information about the RDUs 128 such as, for example, playlists, for each of the RDUs 128. In some embodiments, playlists can be configured to identify a schedule of display content or assets processed by the RDUs 128. Generally, the display content is any object that can be executed by the RDUs 128. In some embodiments, the display screen of the RDUs 128 can be segmented into multiple windows or regions, wherein each window includes a separate playlist. The data repository 114 can further be configured to store content playlists of each segmented window for each display of one or more of the RDUs 128.

Still with reference to FIG. 1, the playlist in one embodiment of the invention is represented by an XML document. In this embodiment, display content can be any object that can be accessed from an XML document, such as, without limitation, a PERL script or a J2EE web application with an XML interface. Such display content can impact the rest of the displays on the RDUs 128. However, such display content need not impact the other information displayed visually by the RDUs 128. Such display content could, for example, cause the RDUs 128 to perform a self test, provide information to other RDUs, provide information to the GSS 102 or perform any other automated task. The data repository 114 can be configured to store more than one schedule for each of the RDUs 128.

The content delivery system 118 is configured to transmit data and content from the data repository 114 to the RCDS 108. In one embodiment, the content delivery system 118 is configured to periodically poll the data repository 114 to determine if there are any changes in content and schedules stored in the data repository 114 and then transmit the appropriate data to the RCDSs 108. In another embodiment, the content delivery system 118 transmits content and schedules from the data repository 114 when instructed by users, for example, through the web portal 112. In still another embodiment, the content delivery system 118 transmits content and schedules from the data repository 114 to the RCDSs 108 based on predetermined criteria (e.g. transmits data periodically, for example, every hour, day, etc.). In other embodiments, the content delivery system 118 transmits data from the data repository 114 to the RCDSs 108 upon request for data by the RCDSs 108.

As FIG. 1 further illustrates, the RCDSs 108 further comprise regional content distributor/local data aggregator 124, which can be configured to serve as an intermediary between the client-side devices and the GSS 102. In accordance with an exemplary embodiment, the regional content distributor/local data aggregator 124 can communicate with the GSS 102, for example, through the Internet network 110 and the RDUs 128 via, for example, a cellular or wireless network 126.

The RCDSs 108 are programmed to “pull” data from real-time disparate sources, including, but not limited to, advertising data and/or real-time traffic, news, sports, weather, financial information, or the like. In addition, the RCDSs 108 can also be configured to retrieve local real-time data and local advertising media based on scheduling information from the GSS 102. The RCDSs 108 can further regularly monitor each client device (for example, the RDUs 128) for vital statistics and return stats to the data repository 114 of the GSS 102.

Additionally, the GSS 102 can transmit the required display contents to the RDUs 128 so that they are available to the RDUs to execute at the scheduled times. Various methods can be employed to determine when the display contents should be provided to the RDUs 128. In some embodiments, the GSS 102 can provide a server that compares the display contents stored for each RDU 128 with upcoming events scheduled for that unit. From this comparison, the GSS 102 can determine when the RDUs 128 will require new assets. The GSS 102 can therefore provide the new display contents before that time. However, the GSS 102 can also compare the memory utilization of the display contents stored in the RDUs 128 to the available memory in the RDU. In one embodiment, it does not provide new resources until after display contents that would have to be deleted to make room for the new display contents are no longer needed.

The RCDSs 108 can further be configured to gather from the RDUs 128 information about the display content that is displayed on the RDUs 128. In some embodiments, the RCDSs 108 can deliver such data to the data repository 114 for storage. For example, the RDUs 128 can display advertisements for which the retailer charges a royalty to display. The RDUs 128 can send information about the displayed content to the GSS 102, which can create and store a record about the displayed content in the data repository 114. The displayed content can be transmitted from the RDUs 128 to the GSS 102 in several ways. In one embodiment, the RDUs 128 transmit the displayed content directly to the GSS 102. In another embodiment, the displayed content is collected by the RCDSs 108, wherein the RCDSs 108 subsequently transmit the displayed content to the GSS 102. In another embodiment still, the RCDSs 108 periodically push the displayed content to the GSS 102. In yet another embodiment, the GSS 102 periodically reads the displayed content from the RCDSs 108 or directly from the RDUs 128. Skilled artisans would recognize that records of actual content displayed can be used to compute royalties due the retailer for displaying advertisements in a retail location or to compute royalties owed to the content providers when display contents are executed.

Referring now to FIG. 1A, one or more of the RDUs 128 in accordance with another embodiment are connected with a data unit 130. The data unit 130 acquires information that is related to activity at the RDUs 128. In one embodiment, the data unit 130 acquires information related to activity at one or more proximate RDUs 128. In other embodiments, the data unit 130 acquires information related to activity at one or more remote RDUs 128 (e.g. located at a different area). The data unit 130 can be configured, based on the collected data, to modify the data and content received and displayed by the RDUs 128. In certain embodiments, the data unit 130 analyzes real-time data to modify the content displayed by the RDUs 128. In other embodiments, the data unit 130 analyzes data from a historical database, such as, for example, from the data repository 114, to modify the content displayed by the RDUs 128. This data collection and modification will be described in further detail below.

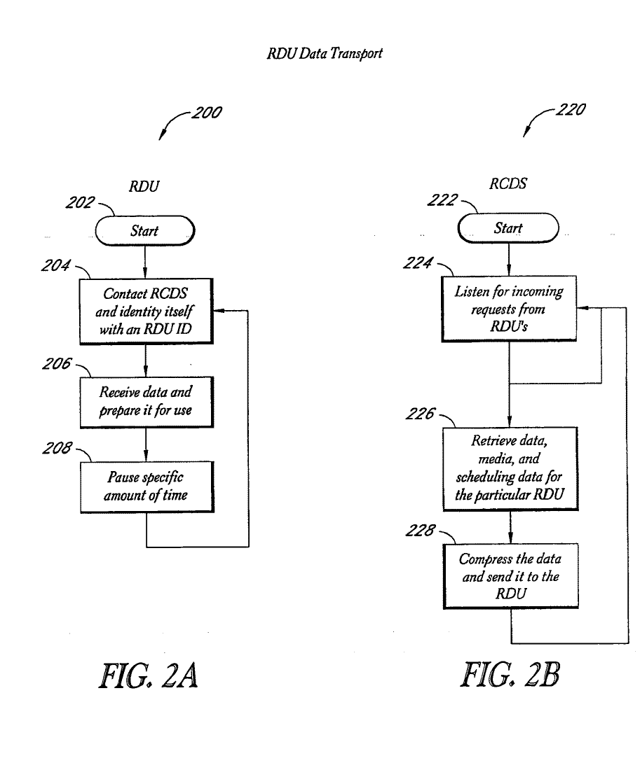

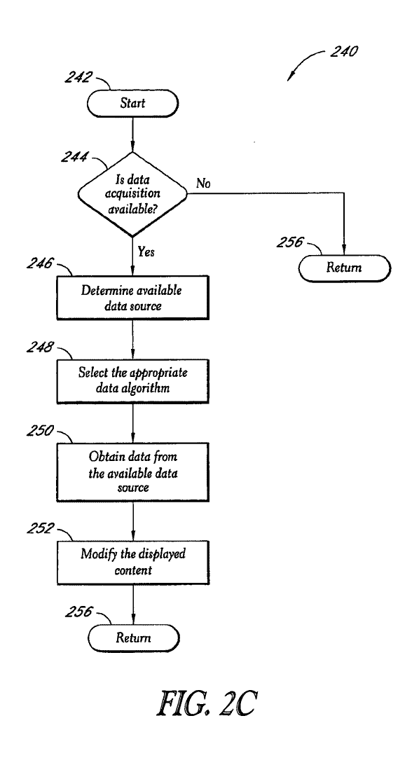

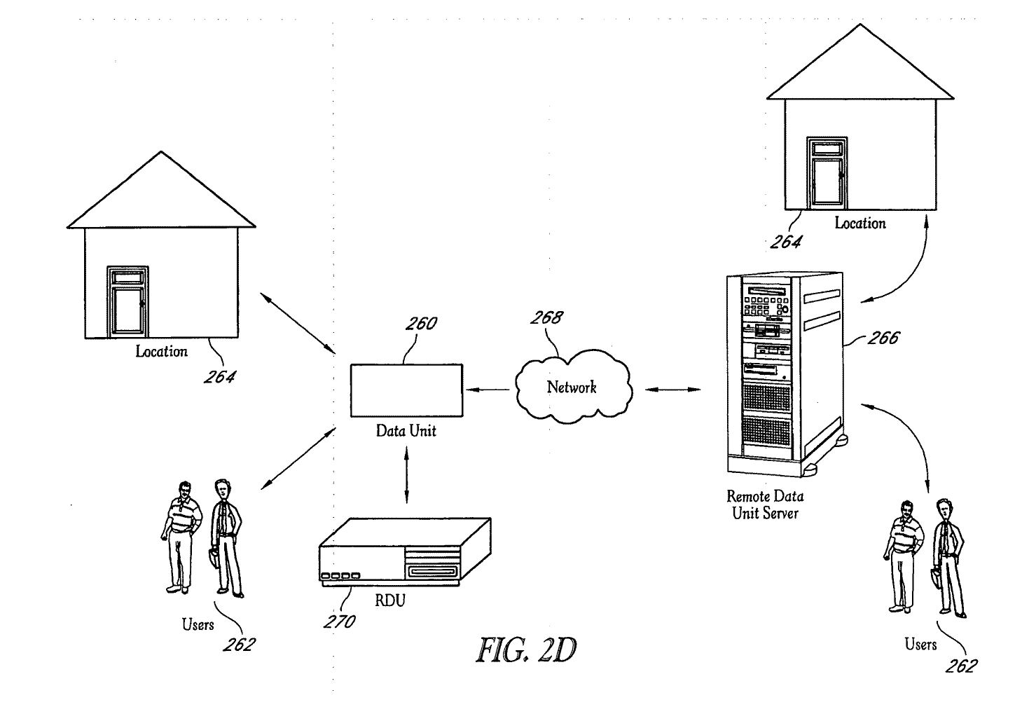

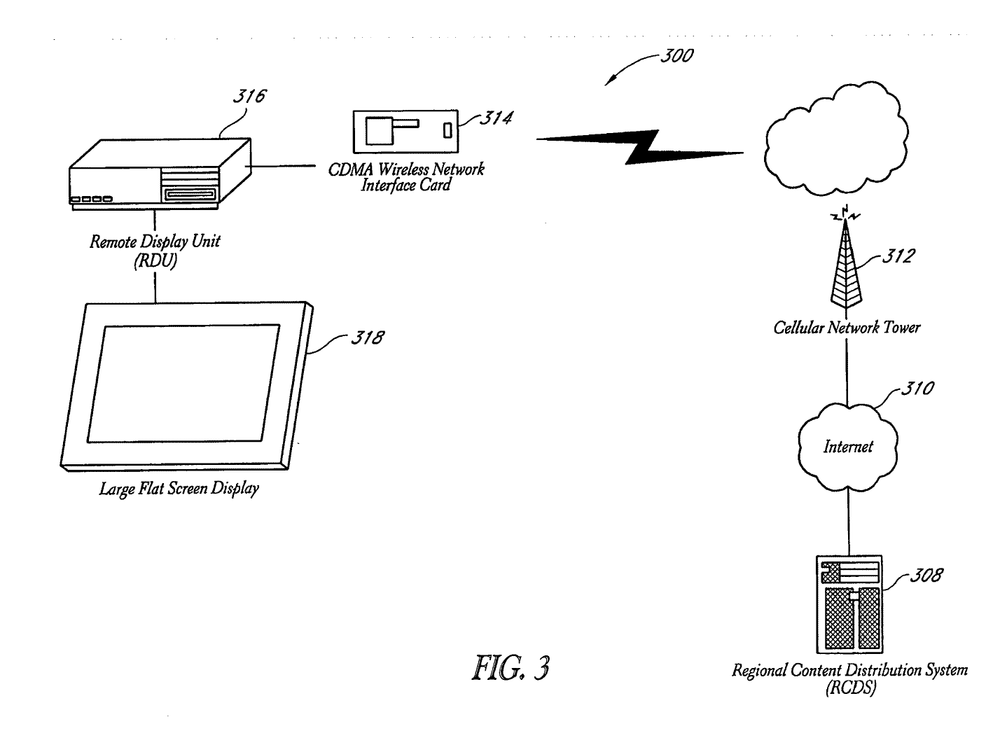

The data and content from the RCDSs 108 can be provided in various manners to the RDUs 128. For example, FIG. 2A and FIG. 2B disclose one embodiment of a method of providing data and content to the RDUs 128. FIG. 2A depicts the processes undertaken by the RDUs 128 whereas FIG. 2B illustrates the processes undertaken by the RCDSs 108. The method will be discussed below with reference to both FIGS. 2A and 2B.

As shown in FIG. 2A, the process begins at start (202). RDUs are configured to contact or “poll” the RCDSs to identify themselves using a unique identification (204), for example, via a wireless connection or an Internet network. In some embodiments, the data can be transmitted to the RDUs via a cellular or other wireless network, such as a CDMA wireless connection, GSM, EDGE, or EVDO or other like networks. It shall be understood that communications between the RDUs, the RCDSs, a GSS and other servers related thereto can be achieved over a wired network or a variety of wireless networks that provide wireless broadband Internet service including but not limited to satellite, cellular, Wi-Fi and WiMax or other IEEE 802.11 standard implemented wireless networks.

An exemplary RDU can suitably receive data and content, for example from the RCDSs, and prepare the data and content for use, and display the data and content to users (206). In addition, the exemplary RDU can store the data and information locally to suitably reduce network utilization. The RDU can then suitably again contact an RCDS for additional or update information, for example after a pause (208).

As FIG. 2B illustrates, an exemplary RCDS can suitably start communications and data delivery (222) by listening for incoming requests from RDUs (224), and then suitably retrieve data, media and other scheduling data for the requesting RDU (226). The exemplary RCDS can perform any of the steps 222-228 concurrently with the steps 202-208 that are performed by the exemplary RDU. The exemplary RCDS can transfer the requested data to the appropriate RDU, e.g., the data can be suitably compressed before sending to the RDU (228), for example, for receipt of date and preparation for use (206). Accordingly, selected data, content and information can be provided at each exemplary RDU depending on the requests or intentions of advertisers, data providers and/or local remote display users and viewers.

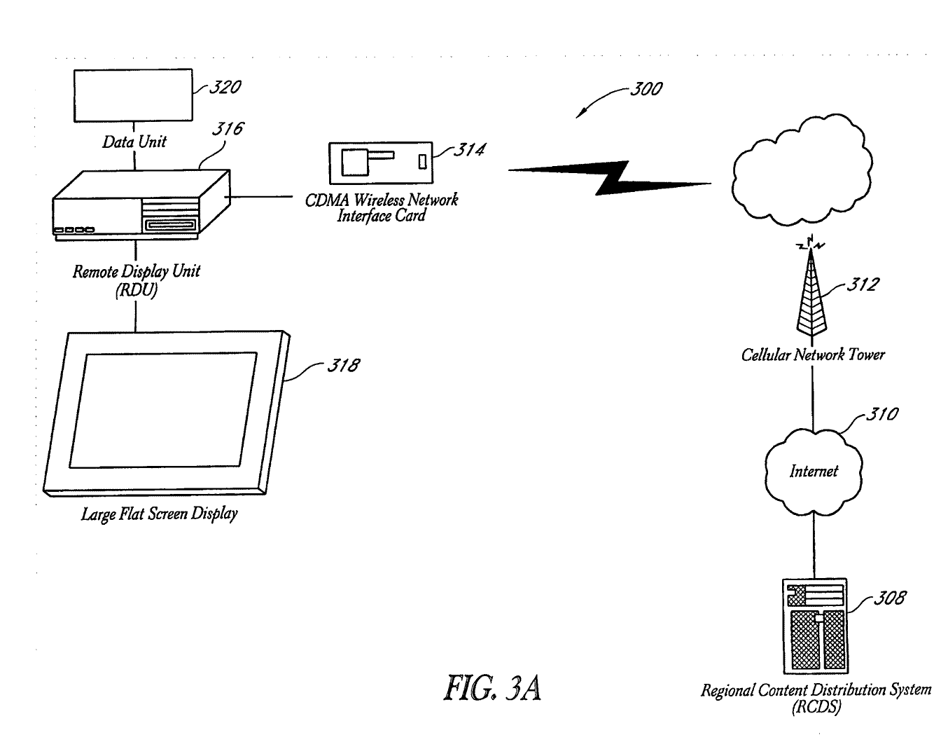

As FIG. 3 depicts, content, data and media can suitably be delivered from the RCDS to the RDU through various networks. For example, with reference to FIG. 3, in accordance with an exemplary embodiment, a cellular communications network 300 can comprise an RCDS 308 coupled to a cellular network tower 312, such as through an Internet network 310 or any other suitable network. Cellular network tower 312 can comprise any system or device for facilitating cellular or wireless communications between devices.

An exemplary RDU 316 can comprise various configurations, including one or more microprocessors, memory devices or other computer components. To transmit requests and receive data, the RDU 316 can suitably comprise a cellular network interface card 314. The RDU 316 can also comprise a display device to suitably display any information, data or other content through a variety of devices, such as, for example, a flat screen display 318, or any other display device. The content displayed on the display device 318 can be generated by the processor within the RDU 316 executing the data received from the RCDS 308.

The RDU 316 can further be configured to display data and content via the display system, such as, for example, the flat screen display 318, using the last known media, real-time data, and schedule, even when the network becomes unavailable. The RDU 316 can also perform health checks at regular intervals and attempt to reconnect to the network as soon as it becomes available.

In certain embodiments, the RDU 316 can function as a controller unit that controls other devices. The RDU 316 that functions as the controller unit can contain copies of the data and content to be executed. As it executes display content according to its playlist, the controller unit sends commands to controlled units causing them to execute the same display content simultaneously. It is not necessary that controlled unit display the same information as controller unit. In some embodiments, controller unit can execute multiple schedules. One schedule can control the information displayed on the display screen 318 associated with controller unit. A second schedule, which can be synchronized with the first schedule, can specify information to be provided to a controlled unit.

Another embodiment is shown with reference to FIG. 3A, including a data unit 320 connected to the RDU 316. As described below, the data unit 320 can collect data that is used in some embodiments to provide information about the effect of the content and to modify the content displayed on display device, such as, for example, the flat screen display 318.

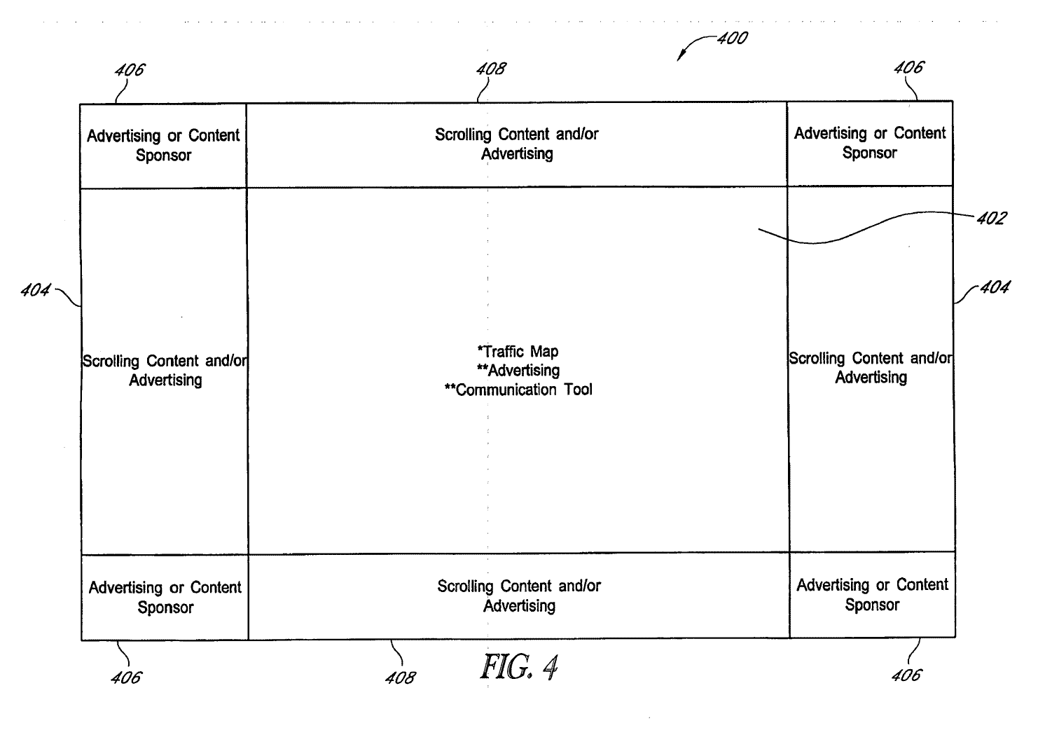

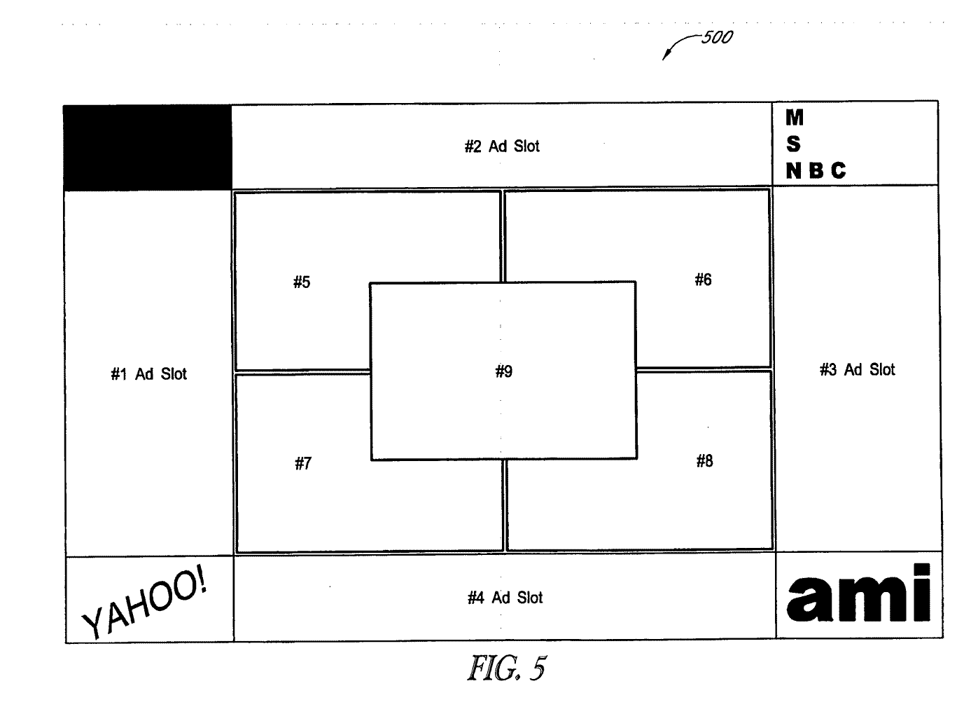

The data, content and other information can be suitably displayed by display device, such as, for example, the flat screen display 318, in various formats. For example, with reference to FIG. 4, an exemplary screen layout 400 can comprise a main display area 402 that includes desired data, such as traffic, communications, advertising or any other data or content, one or more scrolling content and/or advertising regions 404 and 408, and one or more stationary advertising or content sponsor regions 406. The display area 402 can comprise a single region or two or more regions. For example, with reference to FIG. 5, a display area can comprise slot #'s 5, 6, 7, 8 and/or 9. Information in each region can be coordinated to provide significant flexibility in the display of information through the RDU.

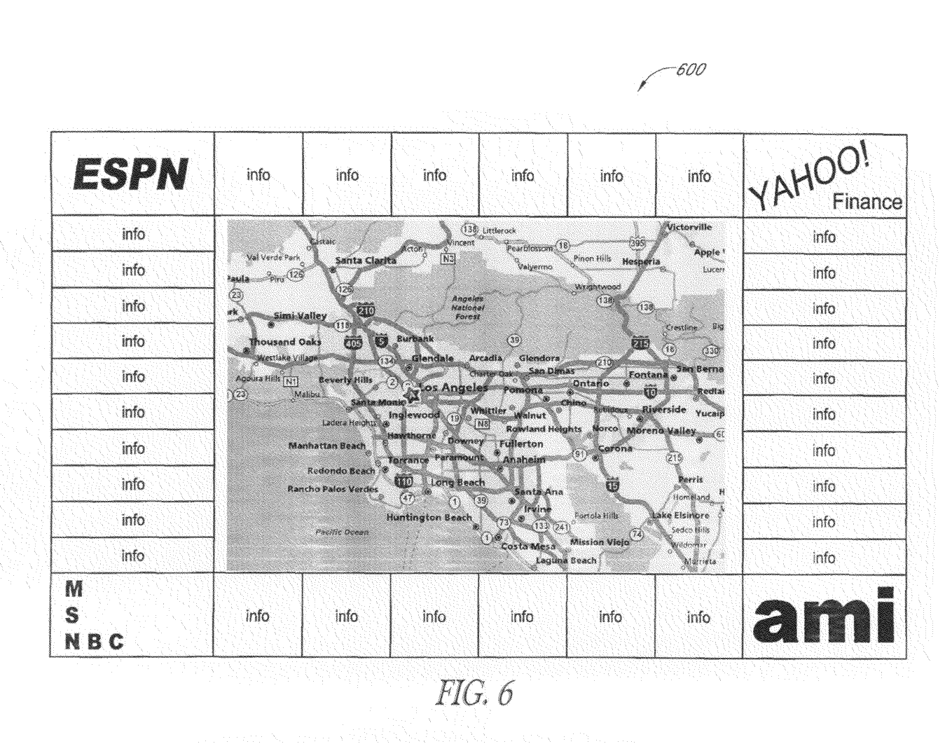

Regions 404, 406 and 408 can be suitably interchanged in any manner, can include scrolling, dynamic or static information, and can comprise various dimensions around or within the display area 402. For example, with reference to FIG. 5, an exemplary screen layout 500 can comprise one or more advertising regions, e.g., #1, 2, 3 or 4 ad slots. In accordance with a further exemplary embodiment, a display screen can comprise a variety of data, such as that illustrated with reference to FIG. 6.

The playlists for display content in each of the regions can be synchronized so that the content in the separate regions within one or more RDUs are synchronized. A simple way to synchronize the execution of display content is to create playlists that execute in the same amount of time. For example, if a video clip displayed in main display area 402 will execute for 30 seconds, the playlist for scrolling content and/or advertising window 408 can specify for an advertisement to be synchronized to the video being displayed for 30 seconds. Multiple display contents can also be synchronized. For example, if a video clip displayed in main display area executes in 30 seconds, the playlist of scrolling content/advertising region could specify a series of display content that collectively execute in 30 seconds. As a specific example, the playlist for content/advertising region could have a still image displayed for 10 seconds, an HTML file for 15 seconds, followed by a Flash animation for 5 seconds.

FIG. 2C illustrates a logic diagram of a method of obtaining information about activity related to RDUs and also possibly modifying scheduled information and displayed content. In some embodiments, obtaining information about activity related to RDUs includes obtaining data about the effect that displayed content has on viewers. At start (242), an RDU is configured to store data locally and to transmit and receive data to an RCDS or GSS. It is next determined whether Data Acquisition is available for the RDU (244). In certain embodiments, Data Acquisition is determined by assessing whether information is available from various data sources, such as, for example, a data unit, or the like. If Data Acquisition is not available, then the process (240) ends (256).

Alternatively, if Data Acquisition is available, then the process (240) determines available data sources from which the RDU can acquire the data. (246). Several embodiments of determining available data sources will now be explained with reference to FIG. 2D. In one embodiment as shown in FIG. 2D, a data source can be a data unit 260 attached to an RDU 270. In one embodiment, the data unit 260 can acquire data from local users 262 or local locations 264. The local users 262 can include, for example, individuals or groups interacting with the RDU 270 or individuals or groups located in the vicinity of the RDU 270. In another example, the local users 262 and the local locations 264 communicate with the RDU 270 through a local network, such as, for example, a wireless network (CDMA, WiFi, etc.). As will be described in more detail below, the data unit 260 can comprise a variety of means for acquiring relevant information from the local users 262 or the local locations 264. The local locations 264 can, for example, be local vendors that transmit product, customer, or transaction information to the data unit 260, as will be described below.

In other embodiments, a remote data unit server 266 provides data, for example, about the effect that displayed content has on viewers, by transmitting data acquired from remote users 272 or remote locations 274 to the data unit 260 over a network 268. In one embodiment, the remote data unit server 266 can obtain information from the remote users 272 or the remote locations 274 utilizing one or more data units dispersed in different geographic locations. In other embodiments, the remote users 272 or the remote locations 274 interact with the remote data unit server 266 through a website or internet service. Some other embodiments can utilize methods described in more detail below.

In certain embodiments, the data unit 260 may comprise a passive data acquisition system such as a web-cam, motion sensor, infrared sensor, pressure sensor mat, an RFID tag reader, a device to identify a WiFi signature, a device to identify the frequency signature of a cellular device, or the like. In other embodiments, the data unit 260 comprises an active data acquisition system. Such a system can be a device allowing direct interaction by a user with the RDU such as a keyboard, mouse, touch-screen, voice recognition system, joystick, custom buttons or switches, a keypad, or the like. In other embodiments, the data unit 260 comprises a device for interacting with wireless user electronic devices enabled with Bluetooth, WiFi, or other wireless systems and able to receive data from these user devices. In still other embodiments, the data unit 260 comprises a card reader such as credit card reader, ID card reader, smartcard reader, or the like. In still other embodiments, the data unit 260 allows for a wired connection with user devices such as with a PDA, MP3 player, portable storage device, or the like.

A data source can additionally be provided by a second data unit (not shown) located at a remote location and able to provide information to the RDU 270 through the Network 268 or through a wireless network, over the Internet, or from the GSS 102.

The data unit 260 can be a system to track real-time data such as data indicating sales information at a nearby retail store or specified location. In other embodiments, such data is not collected in real-time but provided in batch transfers delivered using XML, e-mail, FTP, hardcopy records, or the like. Other information provided to the RDU from a remote location can include information entered or sent to a website or Internet service. In other embodiments, the data unit 260 is configured to receive communication from wireless devices, such as, for example, MMS or SMS messages from a user mobile device. In certain embodiments, a combination of different data units is available to the RDU 270 via local and/or remote connections. Skilled artisans will recognize from the disclosure herein that data and content can be simultaneously provided by more than one data source (e.g. the data unit, the content delivery system, the regional content distributor/local data aggregator, etc.).

With reference again to FIG. 2C, an appropriate data algorithm is selected (248) to process the information obtained from data sources. In some embodiments, the appropriate data algorithm is selected (248) based in part on the data source determined to be available (246) previously. The data algorithm can, for example, indicate which information obtained from the data sources is to be utilized, how that data is processed, and how that data can be stored. For example, the data algorithm can indicate that digital video data obtained from a web cam data unit can be utilized when available according to a simple pixel compare process to determine movement within the video image. That data can be stored directly or further analyzed to determine, for example, a logical condition such as the presence of people moving within the web cam's field of view. The image can also be processed to analyze how many people are standing nearby RDUs, such as, for example, at the display device of the RDU 260 of FIG. 2D. In some embodiments, data representing that condition is transmitted to RDUs or stored.

In some embodiments, certain data is accessed in real-time. In other embodiments, certain data is stored for later analysis. For example, such data can be transferred to the data repository 114 of the GSS 102 and stored in that database indefinitely. Alternatively, data can be stored in another database connected to a plurality of RCDS or RDUs.

Data is obtained (250) in accordance with the selected algorithm. In certain embodiments, behavioral data is collected. For example, a data unit can provide data indicating the size of a crowd or flow of people at a location near the RDU. This can be accomplished utilizing a motion sensor, webcam images processed utilizing pixel comparisons or other digital video analysis tools, pressure sensor mats, or the like. In other embodiments, users actively engaging the RDU can provide behavioral information by indicating preferred content. For example, users can interact with the RDU using a touch screen, wireless device, or some other data unit and indicate that they prefer content related to local news, sports, business, or some other type of information. In certain embodiments, a search engine configured to analyze content stored by a GSS or RCDS is accessible at the RDU or through an Internet website. In these embodiments, obtained data can include search terms provided by a user. Behavioral data can further include purchasing information obtained from local, remote, or online vendors. For example, an RDU located in a shopping mall can obtain data relating to total sales in the shopping mall, the number of sales or value of sales associated with certain vendors within the shopping mall, the number of sales of certain products, or the like. In some embodiments, users can purchase goods at the RDU and information related to this transaction is obtained.

Another type of data obtained can be demographic information. Demographic information can be obtained, for example, by comparing a signature obtained from a WiFi, cellular, RFID, or other electronic device with a database accessible via the Internet or otherwise available to an RDU. This comparison can be used to obtain data such as a person's age, sex, an indication of that person's home or business address, credit rating, language spoken, affiliations, or the like. In other embodiments, a user electronic device can identify demographic characteristics of the user directly and without comparison to a database identifying the user. In still other embodiments, the type of device is identified by its signature and that information is stored as demographic information. Demographic information can also be provided by a user. For example, a user can indicate his or her demographic information using a touch screen, keyboard, or other input device of the RDU. In other embodiments, a user can utilize a computing device connected with the RDU locally or over a network in order to provide demographic information to the RDU. For example, a user can register with a web server associated with the RDU and the registration information can include such data. In other embodiments, a user can send an SMS or MMS message to a phone number associated with the data unit of the RDU.

In one embodiment, the obtained data is used to analyze the effect of content displayed by an RDU. For example, obtained data can be stored and analyzed to determine the efficiency of an advertisement. In certain embodiments, the obtained data comprises information relevant to determining how many people are viewing an advertisement, characteristics associated with those people, and what activities they are engaged in while viewing the advertisement. For example, stored data can include obtained data indicating the number of people in the area of an RDU when an advertisement is being displayed, whether those people are moving past the RDU or standing still, the ages of the people viewing the advertisement, and the purchasing activity at vendor locations in the vicinity of the RDU around the time the advertisement is being displayed. In certain embodiments such data can be obtained from a number of RDUs and the data compiled to provide a more thorough analysis of the obtained data. Furthermore, in certain embodiments advertisers can access a database containing this stored data using a website or Internet service. In some embodiments, such a database interface application can allow the advertiser or other user to select and display a customized view of the stored data. In this way, advertisers can obtain a more complete knowledge of the audience viewing an advertisement and that advertisements effectiveness. Accordingly, vendors can advantageously perform a more accurate cost/benefit analysis of advertising expenditures utilizing this obtained data.

In another embodiment, the obtained data is used to modify content, data and media displayed by and delivered to an RDU (252). In one embodiment, content can be modified by changing the type of content displayed or not displayed in response to the obtained data. For example, when data is obtained indicating a high volume of people in the vicinity of the RDU, advertising content can be displayed. In another example, when data acquired from user interaction, such as through a keyboard input, indicates that one or more users desire to see sports related information, that information can be displayed. In other embodiments, obtained demographic data can induce the RDU to avoid the display of certain content. For example, when demographic data indicates the presence of a high percentage of women, the RDU can not display male focused advertisements if that content is found to be relatively uninteresting to that demographic group. Such obtained data can in some embodiments not only determine what content is displayed, but also what data is requested by and sent to the RDU.

In still other embodiments, the length of time that certain content is displayed by the RDU is adjusted. Thus, while certain content can have been displayed in the absence of the obtained data, that data can induce the RDU to alter the play time of that content. For example, if sports information, such as game scores, were originally scheduled to run for 30 seconds in a slot of the RDU, with news information scheduled to run in the same slot for 30 seconds, the playtimes can be altered in view of certain obtained data so that the sports information can now run for 20 seconds while the news information can run for 40 seconds.

Obtained data can also be used to modify the location on the screen layout that particular content is displayed. For example, obtained data can indicate that certain content should be highlighted and the RDU can therefore display that data in a more prominent position on the screen. For example, with reference to FIG. 5, video content can originally be playing in a slot #5 that can be layered behind slot #9 on an RDU. In response to obtained data that indicates the video playing in slot #5 can be of relatively high interest to local or remote users, then the video playing in slot #5 can be displayed in slot #9. In certain embodiments, a new video is displayed in slot #5. In other embodiments, the video originally playing in slot #9 is displayed in slot #5.

In still other embodiments, obtained data can be utilized to interact with user electronic devices and to update the experience on the user's electronic device. For example, the RDU can be configured to transmit an SMS or MMS message to certain user electronic devices in response to obtained data. This situation can arise when a data unit identifies a cellular phone signature. In other embodiments, a user can register information identifying a means of messaging the user's electronic device, and additionally sign up to receive such messages when certain data is obtained. For example, an RDU can obtain data indicating that a video game system having limited supply is available for purchase from a particular vendor, and in response to that obtained data can transmit an SMS message to a user electronic device when that user requested to be informed of the products availability. In other embodiments, an RDU can interact with user devices by activating wireless communications features on the electronic device in preparation for further data transfer. For example, an RDU can initialize a BlueTooth setting on a user electronic device in response to obtained data.

The process described for acquiring and analyzing data in order to modify content displayed by an RDU can advantageously be used to provide improved effectiveness of advertising and content delivery. Certain embodiments allow for real-time acquisition of interactive, demographic, and behavioral data. These embodiments can in turn advantageously provide for real-time modification of content being displayed. Thus, the content being displayed can be updated to allow for the targeting of dynamically relevant advertisements to users based on information acquired that identifies those users and their current activities.

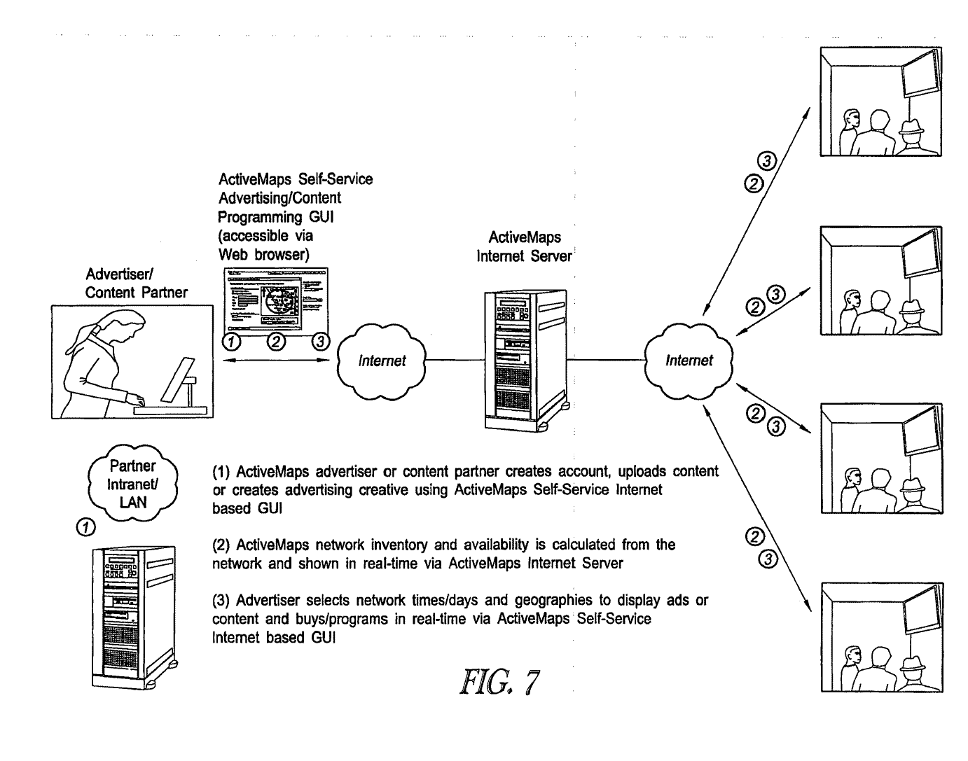

According to a preferable embodiment of the invention, with reference to FIG. 7, an exemplary digital out-of-home network (“DOHN”) comprises a DOHN server in communication with operator terminals. The DOHN server can be connected to one or more operator terminals over a communications network such as the Internet. An operator terminal can consist of various client computers such as a conventional desktop PC, a computer workstation, or other suitable operator interface devices and can be located in any convenient place. An operator terminal provides Internet-based content programming to allow an advertiser or content provider to enter programs or data into DOHN server. The operator terminal can provide a content programming user interface allowing a content provider to directly schedule and upload content to be displayed on each of the RDUs. RDUs are connected to the DOHN server over a communication network such as the Internet as well, and can be wirelessly connected to the DOHN server and other scheduling/content delivery systems described elsewhere herein. It shall be understood that communications between the RDUs, RCDSs, the GSS and servers related thereto can be achieved over a variety of wireless networks that provide wireless broadband Internet service including but not limited to satellite Internet, cellular Internet, Wi-Fi and WiMax or other IEEE 802.11 standard implemented wireless networks. Preferably, a form of encryption is used to ensure that unintended third parties do not gain access to the RDUs. For example, communications through the Internet can be by way of an encrypted tunnel (PPTP). It shall be understood however that any suitable security mechanism can be used.

In some embodiments, a user such as an advertiser or content provider can enter commands and content data to the DOHN server via a Web browser on operator terminal or work station. The operator terminal allows a content provider to upload display content or specify scheduling of display content for RDUs at one or more venues. In a preferable embodiment, each of the RDUs contains multiple display windows, each displaying a different type of data. In this embodiment, the content programming interface allows different content providers in different locations to specify the contents of different windows.

Additionally, operator terminal can allow a content provider to retrieve status information from the RDUs in one or more venue. Status information may, for example, be in the form of log files recording display content executed by those RDUs. The operator terminal can display this information to a content provider or can process one or more reports for the content provider. Such information does not need to be provided directly to a human entity. It may, for example, be used in an automated billing system to generate bills to advertisers and other content providers whose content was displayed on the RDUs within a retail location. Alternatively, status information can be used to generate royalty payment reports needed to pay royalties to content providers whose content was displayed in the display units within a retail location.

A content programming user interface can be presented to a content provider such as an advertiser through any suitable operator interface device. The content programming interface can include control constructs as are traditionally used in graphical user interfaces for personal computers. These controls allow a content provider to associate specific display content with a specific display area for a specific group of RDUs. The content programming interface can include a menu bar such as those incorporated into Microsoft Windows operating systems. A menu bar provides a means for a content provider to access any of the primary functions of the user interface. A list window displays and folders can display information in a hierarchical fashion. The controls can determine which type of information is displayed in list window. In an alternative embodiment, the controls can be selected such that playlist schedules are displayed in list window for viewing and editing.

In a preferable embodiment where the RDU screen is divided into at least three different display regions or windows, a number of playlist schedules can be organized into three groups: those for a main display area, those for a scrolling content/advertising area, and those for an advertising or content sponsor area. Multiple playlist schedules can be created within each type. For example, a content provider can program a playlist schedule for current play and another program schedule to start on a specified date and time under the category of scrolling content/advertiser area. A content provider can wish to create multiple playlist schedules to allow different playlists to be specified for different RDUs or groups of RDUs. Alternatively, multiple playlists can allow different playlists to be specified for the same groups of devices at different times. Multiple schedules can be provided to allow rapid changes of the display content scheduled to be displayed at groups of RDUs.

Each playlist schedule provides a mapping between RDUs and specific playlists. Playlist schedules can be created, but are not effective until a content provider invokes the command to transmit, which causes the DOHN server to send playlists to each RDU for which a playlist is specified. In a contemplated embodiment, only “new” playlists will be transmitted. In this way, playlists are only transmitted when they are different from the playlist previously transmitted.

A content provider can specify the relationship between device groups and specific playlists needed to create a playlist schedule. The playlist schedule can be located in a drill down window. In an example, a window can show RDU groups are identified under different names and categories. Each RDU group has associated with it a control that allows further detail in the hierarchy to be revealed or hidden. Highlighting a playlist in this window causes details of that playlist to appear in the window below.

As used herein, the term playlist is not used in a restrictive sense, but simply to signify any content to be displayed, and not the particular content or a particular order. Thus, a playlist can comprise any content to be displayed in a device. For example, each playlist can consist of a series of content for display. Accordingly, when the playlist schedule for current play is published, the RDUs in the device group identified will receive a playlist that causes the processor associated with those RDUs to first display within the scrolling content/advertising area an image corresponding to the first display content listed in the playlist. The processor within the RDU will display this image followed by the information generated by the second display content listed in the playlist and cycle through all of the display content in the playlist. The display content can be of different formats. For example, this second display content can be web application that retrieves information about bus schedules or arriving in departing buses from a web server and display that information in scrolling content/advertising area.

The content programming interfaces provided in accordance with some embodiments of the invention allow a content provider to change the playlist, device groups, or playlist schedule by using the controls on the GUI. For example, a window includes a control that allows a content provider to create or add an asset or display content to an existing or new playlist. A user can initiate a wizard program that allows display content to be added to the specified playlist. A wizard window may, for example, appear superimposed on the content programming interface. As is known in the art, a wizard is a program that walks a user through series of steps required to perform a specific function. These self-service or self-help types of programs are provided in accordance with this aspect of the invention to give users greater flexible control over media presentation, scheduling and advertising. The wizard window could give the content provider a choice of uploading new display content from a local or remote source or selecting existing display content stored in a local or system database. Once the content provider makes a choice, the content provider can move to the next step in the process controlled by the window by operating the control.

The next step in the process can include adding display content to a playlist when the content provider has elected to add existing display content. In wizard window, a content provider can specify a display content format. Specifying a display content format causes a list of all display content of that format already created to appear in a list window. The content provider can highlight in list window one of the display content. When particular content is selected, a content provider can then move to the next step in the wizard.

When a content provider indicates through wizard window that the content provider wishes to upload new display content, the wizard window would guide the content provider through identifying the display content and providing it with a name such that it could be referenced by the display system. As described above, display content can be digital files. Identifying the display content can include specifying the location of the digital file so that it later can be accessed or loaded into DOHN server. Other information on the display content can also be gathered. For example, the owner of the display content can be recorded and stored in a database such as the scheduling database to facilitate payment of royalties.

The wizard window also allows the content provider to change the order of the display content in the playlist. By highlighting an item in list window and operating the controls, a content provider can move a particular entry up or down in the playlist. Upon completion of the ordering of the playlist through wizard window, the content provider can select to finish the wizard, returning to the content programming interface.

When the content provider has completed changes with the playlist, the content provider can elect to apply those changes by using an application control. When the application control is operated, each playlist schedule is updated to include the new playlist. When that playlist schedule is next transmitted, the new playlist will be provided to each RDU scheduled to execute that playlist.

Other controls in content programming interface allow the content provider to perform other functions that specify the scheduling of display content on devices throughout the RDU. For example, a control can allow a content provider to highlight display content in a playlist appearing in drill down window and remove that content from the playlist.

Similar wizards and control functions allow a content provider to specify information about RDUs, RDU groups or display content. For example, by activating control, content programming interface would reconfigure to display information on RDUs in a list window. Information can be sorted by RDU group, RDU device type, RDU location or in any convenient way. Content programming interface can contain controls (not shown) that specify the criteria for grouping RDUs on the window.

When list window is configured to RDU devices organized by RDU groups, selecting a group from list window can cause a list of RDUs in that group to appear in a drill down window. Such a drill down window can include controls corresponding to the control to add or remove display content. Such controls in connection with a RDU group drill down window would allow RDUs to be added or removed to each RDU group. Likewise, selecting the added RDU device control can invoke a wizard walking the content provider through the steps of selecting an RDU. Such a wizard can walk the content provider through the steps of identifying an RDU device to the group.

Other wizard screens can guide a content provider through the process of identifying a new RDU device to the system. For example, when a content provider is entering a new RDU, wizard screen can contain fields to collect information about the RDU. Such information can include RDU name, the type of RDU device, the size of the RDU (in pixels) and a location for the RDU. Each RDU can be accessed through an IP address. Wizard screen can also have a function to determine an IP address for the RDU.

Likewise, display content can be managed through the content programming interface. For example, activating control can cause a list of display content to appear in list window. Display content can be grouped by content type, display content owner or in any convenient manner. Wizard screens can also allow the uploading of new display content. As described above, display content can be stored as digital files that can be executed and the wizard can guide the content provider through the process of identifying the file to use as display content. It shall be understood that other user interface features and automated programs besides wizard programs can be selected herein to select and display playlists herein.

The content programming interface as discussed is one example of the manner in which display content can be scheduled on a plurality of RDUs throughout the content distribution system. Any suitable mechanism can be used. For example, an interface window can optionally be used to allow a user to “group” display content. When a display content that has been “grouped” with other display content is executed, the RDU executing that content also executes any grouped display content in other display windows.

One of the display content can be dominant because the scheduling of that display content can drive the execution of the grouped content. A number of fields can be provided for information about the dominant display content, such as a field for the length of the content. A variety of controls can allow a content provider to indicate the layout of the RDU on which the dominant display content will be displayed and the display area in which the dominant display content is to be displayed when the grouping applies. A list box can be available to a user to select the layout and to select the desired display areas.

The user interface can further include a window with multiple tabbed areas that correspond to one of the display areas in the layout indicated in list box that might be synchronized to the display area selected in dropdown list box. Tabbed area contains a list of display content to be displayed in one of the display areas when dominant display content is displayed in the main display area. In one example, list can specify what other specified display content should play, in what order, when that specific dominant display content is displayed in the main display area.

A group of controls allows a content provider to perform such functions as adding display content to list, deleting display content from the list, changing the order of display content in the list or otherwise altering properties of the display content in the list. List can be thought of as a “grouped playlist” and any operations that are performed on a playlist can optionally be performed on the list. Entries in each tabbed area can create grouped playlists for each of the display areas of the RDU.

When the grouping is applied, the grouping information is stored in a scheduling database. The grouping information can then be provided to RDUs. Grouping information can be provided in any suitable manner. For example, grouping information can be provided using the same communication channels as are used to publish playlists to RDUs. Grouping information can be provided to all RDUs when transmitted or can be provided selectively only to those RDU devices receiving playlists in which the dominant display content appears.

When the dominant display content is executed in the specified window, the RDU then executes any grouped playlists for the other display areas. If a display area is already executing a playlist when the dominant display content begins to execute, that playlist is interrupted. When execution of the dominant display content is finished, the RDU resumes execution of the playlists for each display area. The playlists can resume at the point where they were interrupted or can resume at the point they would have reached had they not been interrupted to execute the grouped playlist.

In this way, synchronization can be readily provided within display windows of an RDU. This concept need not be limited to grouping of display content executed on the same RDU. The grouping concept can be extended to grouping of display content executed on different RDUs. As described above, the content distribution system can be constructed such that RDUs are connected to a network, allowing messages to be transmitted between RDUs. When dominant display content is executed on one RDU, it can send a message to other RDUs, containing grouped display windows, to execute grouped display content in those windows.

In one embodiment, scheduling is performed on “segments.” A segment is a group of playlists specifying the actions of an RDU or a group of RDUs at one time. For example, a segment for RDUs having three video windows can consist of three playlists, one for each video window. A content provider input screens within a GUI can facilitate the grouping of playlists into segments specified in any suitable manner.

The content programming interface herein can further provide a graphical representation of time slots in which segments can be scheduled. Fields allow a content provider to specify a specific day. When a day is selected in field, a timeslot schedule for the selected day is displayed in another field. This field can be segmented into multiple time slots. When segments are specified to be executed in certain time slots, they are said to create a content block. The content programming interface includes a group of controls that can be used to add or delete content blocks. The group of controls within group can also be used to modify the parameters specified for any content block.

When a control is activated to add or modify a content block, a separate user interface can be presented. The separate interface contains a window in which segments available for programming are displayed. Segments can be displayed hierarchically or in any other suitable fashion. The controls can be added to allow a content provider to select or de-select segments for inclusion in the content block. Selected segments can be identified to the content provider in any convenient means, such as by listing them in a window.

Furthermore, the separate interface includes a group of controls to allow the content provider to specify the start and end of the content block. Any suitable control interface can be used. For example, drop down list boxes can be provided to allow a content provider to select the start time of the content block. The content block can end once the segments selected for the content block are executed. Alternatively, controls can be provided to allow the user to specify an end time to the content block. In this scenario, display units can be programmed to respond to situations in which the segments in the content block either are executed before the specified ending time or are still executing when the specified ending time is reached, such as by looping through the scheduled segments but interrupting execution of the segments at the specified ending time. As a further alternative, the system can be capable of determining the end of a content block in either fashion and the content provider could be given the option to specify the ending time of the content block or to allow the system to determine the end of the content block based on the length of the segments programmed into that content block.

The user interfaces provided herein can also contain a group of recurrence controls. Recurrence controls can create multiple copies of the same content blocks at a specified frequency. For example, the recurrence controls can specify recurrence at a frequency that can be daily, weekly, month, etc. The separate interface can also include range controls that allow a content provider to specify the length of time for which the recurrences should be scheduled. The range can be specified based on an ending date or can be specified based on some number of recurrences. Regardless of the specific manner used to specify the range, when a content block is scheduled with a recurrence, the DOHN server providing the content programming interface can enter in the schedule multiple copies of the content block at the recurrence frequency throughout the recurrence range. In addition, the interfaces can further include a group of controls that specify actions for each recurrence of the content block. For example, one control in the group can specify that the exact same content is executed for each recurrence. Alternatively, a control can specify that the system check for updates to each display content in the content block for each recurrence. Such a feature can be useful, for example, when display contents are generated automatically.

Additionally, the user interfaces herein can also include a priority field. For example, the priority field can be a dropdown list box, allowing a finite number of ordered choices. As described elsewhere herein, the content provider can be provided with multiple methods to specify the display contents to be executed in each display area in each RDU. Whenever multiple display contents are specified for the same display area of the same RDU, the RDU will execute the highest priority. Priority can be implied. For example, it was described above that grouped display content interrupts scheduled display content. Thus, grouped display content has an implied priority higher than scheduled display content. However, the system can allow a content provider to specify a priority of display contents to control whether one display content interrupts another. Here, a priority can be specified for the content block and all display contents executed within the content block share that priority, but other suitable methods for specifying priority can be used, if desired.

The user interfaces provided in accordance with one embodiment of the invention can further include a group of controls that specify the behavior of the RDU when the content block interrupts execution of another playlist. Options can include resuming the prior playlist at the point of interruption or resuming the playlist at the point at which it would have been playing had it not been interrupted intentionally or accidentally due to a disruption in communication or power etc.

Another aspect of the invention provides a user interface designed for an advertiser that facilitates the targeting of advertisements to particulars groups of customers. An advertiser from a remote location over the Internet, preferably from a Web browser, can access an advertisement center to launch a targeted advertising campaign. After the advertiser creates an account and logs-in over a user interface as described elsewhere herein, a series of screens can be presented offering a series of choices in the manner selected advertising or content is displayed at remote locations. This aspect of the invention offers a significant improvement over a typical DOHN today in which advertising is untargeted. Unlike television or radio broadcast networks, each display in a DOHN provided in accordance with some embodiments of the invention does not necessarily receive and display the same advertising and content signal. Moreover, advertising and content can be targeted from a remote location to a particular audience as opposed to accomplishing this in the typical manual fashion at the local signal or display level (e.g. a local radio or TV station that manually insert ads into an otherwise national broadcast).

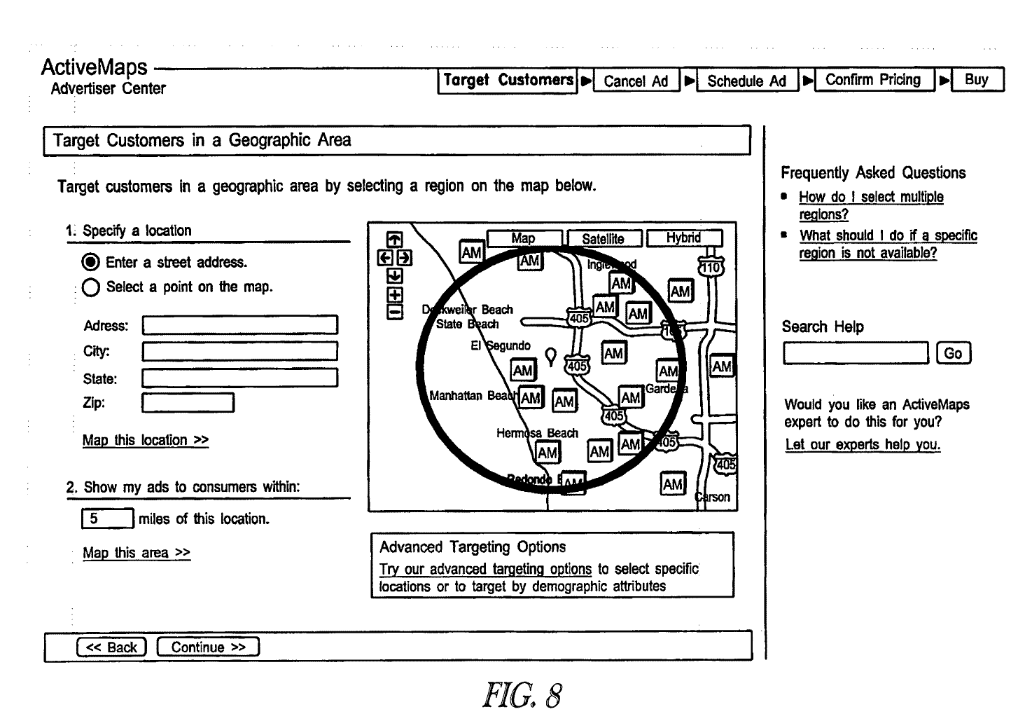

The screenshots depicted in FIGS. 8-10 describe an embodiment of the invention that provides a user interface for an advertiser center system. The user interface graphically depicts the targeting capabilities within DOHNs such as those shown in the figures. The targeting capabilities of the system can be carried out over a network as described elsewhere herein and can be based on a selected number of factors. Methods are provided for customizing the programming of advertising and content in DOHNs based on a number of targeting factors, including but not limited to the following: (1) the specific ID number of an RDU, a panel or other display device (e.g. device ID #12345); (2) the geographic location of each display device (e.g. device located at 123 Main Street, Anytown, State, USA); (3) the demographic characteristics of an audience that typically views or is exposed to the display device (e.g. females between the ages of 22 and 34, men with annual household incomes of greater than $75,000); and (4) the time of day and time of week in which the advertising or content is displayed (e.g. only between the hours of 8 am and 12 am on Mondays, Tuesdays, Wednesdays and Thursdays). A preferable method according to the invention provides targeting advertising and content based on the grouping of display devices based on any of the targeting factors such as those enumerated above (1-4). For example, an advertiser can be able to select one or more groups of displays by device ID, location, the demographic characteristics or time of day/time of week characteristics that could be targeted. In an embodiment of the invention, the display devices for a particular retailer (Starbucks Coffee) can be assigned a series of ID numbers (SB 123, SB 124, SB 125 etc) for its stores located throughout a local, statewide or wider region. As a result, targeted advertising can be delivered to consumers beyond just the physical location of display devices but through a retail chain having stores spread across a wide area. Advertisements can be also displayed at all display devices within a selected zip code or within a defined mile radius of a certain location. It shall be understood that the various embodiments of the invention are not limited to the targeting factors expressly set forth above but includes others also known in the field.

According to a preferable embodiment of the invention, the step of targeting selected advertising can be included as just one step in an overall self-service process of delivering advertisements over a DOHN. An advertiser or user can create an account and establish a user-ID and password as is known with other online accounts. Methods and systems are provided herein that allow advertisers to deliver content and advertisements by themselves without relying on or paying a third party. These self-service processes can comprise one or more of the following steps of: targeting customers according to selected parameters (who/where); creating or selecting advertisements to be displayed (what); scheduling the advertising for display (when); confirming the pricing for the desired advertising (how much); and buying the desired advertising as selected by the user in real-time over an Internet connection, preferably through a Web browser such as Microsoft Internet Explorer.

When targeting customers within a geographic area, as shown in FIG. 8, a user or advertiser can select a region in a number of different ways through an interface provided in accordance with this aspect of the invention. The user can specify a location by street address and zip code that can be entered in displayed fields. Alternatively, a pictorial representation or map of a surrounding geographic region can be displayed for the location with navigational arrows such as those provided by Google Map or Mapquest services. The map can preferably identify locations of display units as shown that are installed at various sites and cities within the selected region (AM logos superimposed on map). Each display device can be pre-assigned a specific ID number for targeting purposes. Starting from a selected initial location, advertisements can be targeted within a defined range or distance (number of miles) from that location. Accordingly, each of the display devices falling within the specified range provided can be included within a group of units that will display the desired advertising selected by the user or advertiser.

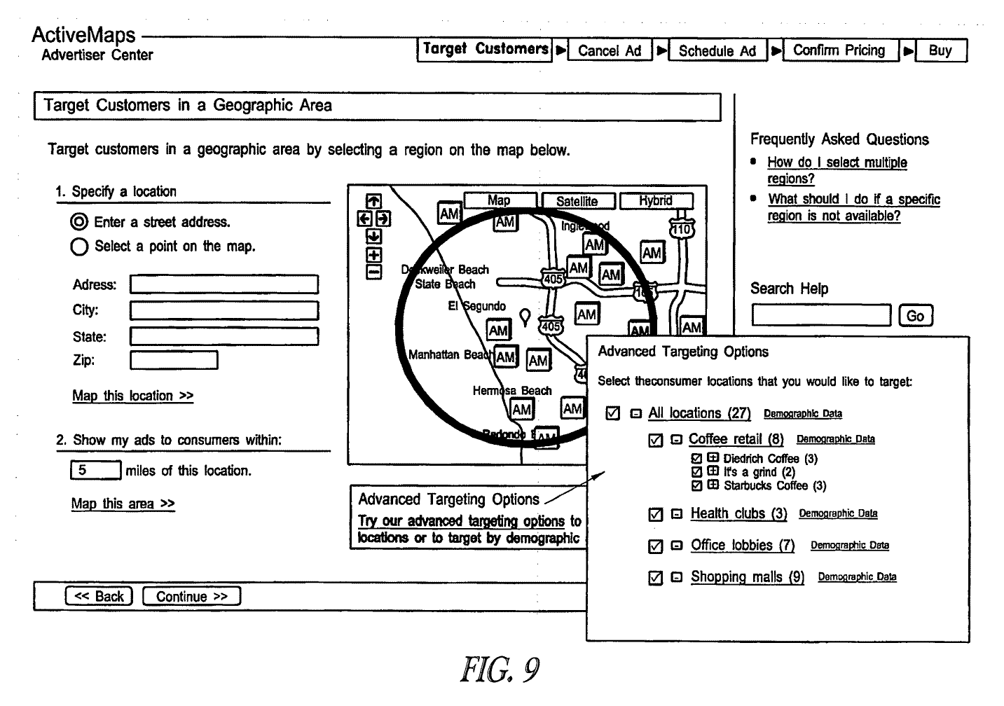

A preferable embodiment of the invention provides a user interface with targeting options as illustrated in FIG. 9. When the user selects the targeting option, a pop-up window can be displayed that offers greater targeting capabilities for delivering advertisements and content. For example, any currently available consumer locations can be displayed allowing the user to designate which kinds of retailers or retail stores can be targeted (Coffee retail, Health Clubs, Office Lobbies, Shopping Malls), or optionally, all locations within the DOHN(s) could be targeted (All locations). Each consumer location option can be displayed with a box that is checked-off when clicked-on by a mouse or other input device. The number of display devices or locations within a DOHN can be provided parenthetically (Coffee retail (8)) and additional demographic data for the particular consumer location can be displayed to the user by clicking-on an optional link (Demographic Data). The user can be offered more information and attributes of the kinds of consumers (age/sex/annual income) who can visit various locations or retailers. Within a consumer location category (Coffee retail), a list of subcategories or specific retailers (Diedrich Coffee, It's a Grind, Starbucks Coffee) can be displayed hierarchically. The subcategory options maybe optionally displayed or expanded on the interface by pressing a (+) button or collapsed by pressing a (−) button as with most common user interfaces. Furthermore, each subcategory can further provide the number of locations or stores where a display device is installed (Starbuck Coffee (3)) and allow the user to pinpoint down to and target a particular display device (identified with a unique ID number) or store. Accordingly, advertising and content can be optionally targeted at all Coffee retail shops within the DOHN(s), or just a particular coffee retail chain (Starbucks coffee), or just a particular display device or store within the retail chain (Westwood, Calif.), which could alternatively have more than one display device. Moreover, the pricing for each of these advertising and content options can vary according to numerous factors including how many display devices are selected, and where the display devices are physically located (advertising over display devices at locations in Beverly Hills can cost more than El Segundo locations, for example). The user or advertiser can therefore create and run an ad campaign that fits within a certain budget that covers only certain consumer locations that reach the customers of interest on a panel by panel (or display device) basis. The same type of targeted advertising and content delivery can be accomplished for other retail markets such as Health clubs, Office Lobbies and Shopping malls etc. It shall be further understood that any type or number of consumer location categories and subcategories can be created other than those expressly shown in the figures provided in accordance with this aspect of the invention.

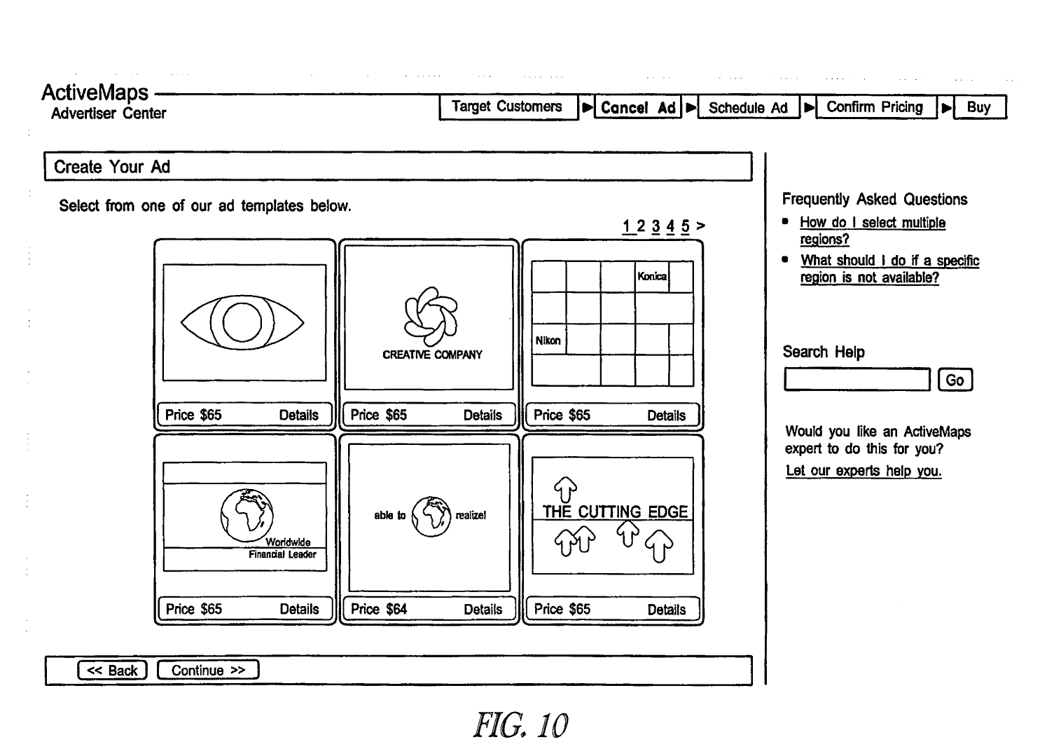

When creating an advertisement or other content, as shown in FIG. 10, a user can be presented with a selection of choices from a predetermined list of advertising templates displayed across a series of pages over the user interface. The user can flip through the pages of templates by clicking-on page links or pressing back/continue buttons as is known in the field. The price for each advertisement template can be displayed along with further related details. Alternatively, the user can create a new advertisement or content to be uploaded through the user interface. An optional pop-up window can be provided that allows the user to Browse through available directories or access the desktop of the personal computer on which the Web browser is operating. A remotely stored file can then be therefore uploaded to the advertisement center through the user interface in accordance with this embodiment of the invention.

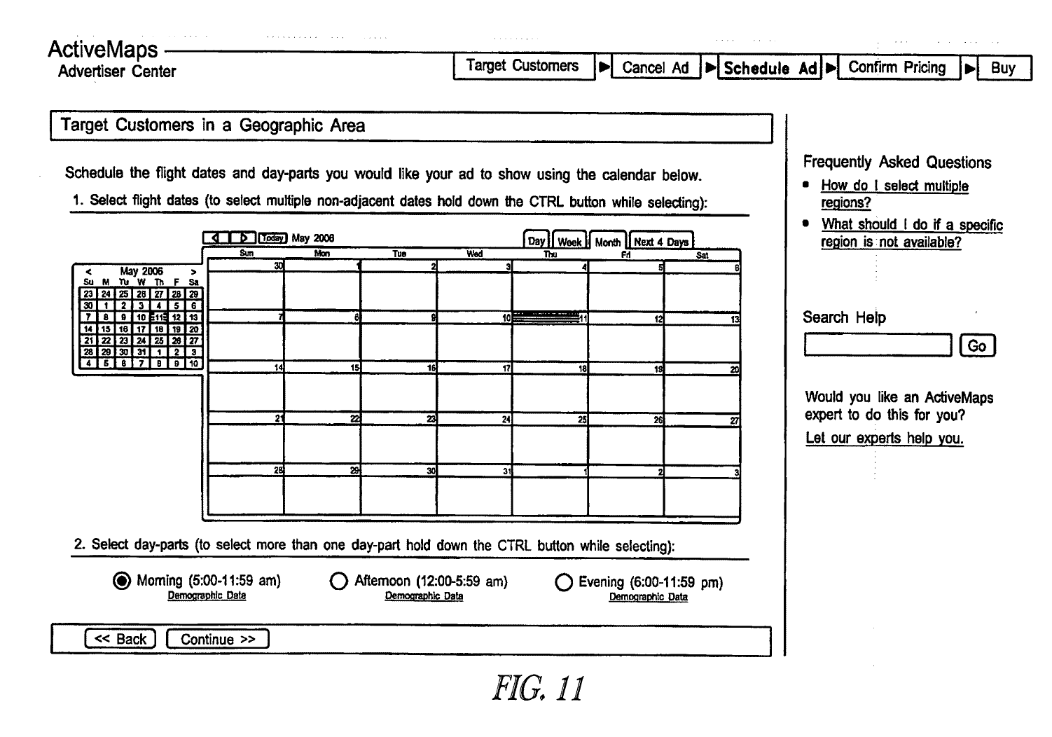

When scheduling the selected advertising for display, the user interface can next present a screen (Schedule Your Ad) that allows the user or advertiser to set the desired flight dates and portions of a day (day-parts). Various time periods can be created and displayed on schedule screen depending on how long an ad campaign can run (day, week, month, next 4 days). As shown in FIG. 11, the user can first select one or more flight dates by clicking-on particular days or series of days (by holding down CTRL button while selecting). In a second step, the user can select one or more day-parts which can be broken down into different predefined times of the day (morning 5 a-1159 a, afternoon 12:00 p-5:59 p, evening 6:00 p-1159 p). For each day-part, additional demographic data can be available to a user to explain more about the consumers for the selected location(s) at which advertisements or other content will be targeted. For example, younger adults or teenagers can be reached more often during morning or afternoon day-parts while older adults can be targeted by scheduling advertisements and content during later parts of the day or evenings. As with other targeting factors described herein, the frequency in which created advertisements and content are run, and during which day-parts, will often affect the pricing for such advertising and content. More frequently run advertisements during peak business hours for certain locations can be charged a premium, while scheduling them less often and/or during of-peak hours will likely result in lower pricing. Accordingly, a user can schedule and target advertisements with the user interfaces and methods provided herein to run ad campaigns that can be created and modified in real-time to fit any desired budget independently and remotely over the Internet within Web browser environment.

The present invention has been described above with reference to various exemplary embodiments. However, those skilled in the art will recognize that changes and modifications can be made to the exemplary embodiments without departing from the scope of the present invention. For example, the various operational steps, as well as the components for carrying out the operational steps, can be implemented in alternate ways depending upon the particular application or in consideration of any number of cost functions associated with the operation of the system, e.g., various of the component and methodologies and/or steps can be deleted, modified, or combined with other components, methodologies and/or steps. For example, various of the systems and devices, such as within the global scheduling system or the regional content delivery system, can suitably utilize compression algorithms to reduce network usage and/or include failure recovery mechanisms to efficiently transfer large files that are susceptible to cellular connection interruptions. Further, it should be noted that while the method and system for media content distribution for digital signage networks and applications is described above is suitable for programming and use by a user proximate the RDUs, the system can also be accessed remotely, i.e., the user can operate through a remote display having information transmitted in various manners of communication, such as by satellite/wireless or by wired connections such as IP or digital cable networks and the like. These and other changes or modifications are intended to be included within the scope of the present invention, as set forth in the following claims.

What is claimed is:

1. A media and content distribution system, the media and content distribution system comprising:
a global scheduling system (GSS) configured to collect data and content, wherein the GSS further comprises:
a global data aggregator that obtains the data and content from content providers;
a data repository that stores the data and content;
a web portal that manages and schedules the data and content; and
a content delivery system that distributes the scheduled data and content;
an Internet network; and
one or more regional content delivery systems (RCDSs) configured to receive the data and content, wherein the one or more RSDSs communicate with the GSS via the Internet network, and wherein the one or more RCDSs further comprise:
a regional content distributor/local data aggregator configured to receive the data and content from the GSS;
a cellular or wireless network;
one or more remote display units (RDUs) configured to display the data and content, wherein the one or more RDUs are in communication with the regional content distributor/local data aggregator via the cellular or wireless network; and
a data unit configured to acquire information related to activity at the one or more RDUs, wherein the data unit is in connected to at least one of the one or more RDUs.

2. The media and content distribution system according to claim 1, wherein the data unit is further configured to modify the data and content displayed by the one or more RDUs.

3. The media and content distribution system according to claim 1, wherein the data unit is further configured to modify the data and content displayed by one or more RDUs based at least in part on information related to activity at the one or more RDUs.

4. The media and content distribution system according to claim 1, wherein the data unit is configured to analyze real-time data.

5. The media and content distribution system according to claim 1, wherein the data unit is configured to analyze historical data.

6. The media and content distribution system according to claim 4 or 5, wherein the data unit is configured to modify the data and content displayed by the one or more RDUs based on the real-time data or the historical data.

7. The media and content distribution system according to claim 1, wherein the web portal is configured to authorize users to schedule media delivery to one or more RDUs or add, manipulate, remove or otherwise manage data and content.

8. The media and content distribution system according to claim 1, wherein the data unit is further configured to acquire data from local users or local locations.

9. The media and content distribution system according to claim 8, wherein the local users or the local locations further comprise individuals or groups interacting with or are located in the vicinity of the one or more RDUs.

10. The media and content distribution system according to claim 8, wherein the local locations comprise local vendors that transmit product, customers, or transaction information to the one or more RDUs.

11. The media and content distribution system according to claim 8, wherein the local users and local locations communicate with the one or more RDUs through a local network.

12. The media and content distribution system according to claim 1, wherein the data unit is further configured to acquire data from remote users or remote locations.

13. The media and content distribution system according to claim 1, wherein the data unit is further configured to acquire data from remote users or remote locations using a remote data unit server.

14. The media and content distribution system according to claim 1, wherein the data unit is further configured to acquire data from remote users or remote locations over a network.

15. The media and content distribution system according to claim 12, wherein the remote users and the remote locations are configured to provide information related to activity at the one or more RDUs through a website or Internet service or in batch transfers.

16. The media and content distribution system according to claim 1, wherein the one or more RDUs are configured to communicate with a combination of different data units via local and/or remote connections.

17. The media and content distribution system according to claim 1, wherein the one or more RDUs are configured to store data locally.

18. The media and content distribution system according to claim 1, wherein the one or more RDUs are configured to transmit data to the one or more RSDSs or the GSS.

19. The media and content distribution system according to claim 1, wherein the one or more RDUs are configured to receive data from the one or more RSDSs or the GSS.

20. A method of acquiring information about activity related to RDUs, the method comprising:
determining whether data acquisition is available for RDUs;
determining available data sources from which the RDUs can acquire data;
selecting the appropriate data algorithm to process the data acquired from the available data sources; and
obtaining data about activity related to the RDUs in accordance with the selected data algorithm.

21. The method of claim 20, wherein acquiring information about activity related to the RDUs further comprises modifying content, data and media displayed by and delivered to the RDUs.

22. The method of claim 21, wherein modifying content, data and media displayed by and delivered to the RDUs further comprises modifying displayed content in response to the obtained data.

23. The method of claim 21, wherein modifying content, data and media displayed by and delivered to the RDUs further comprises adjusting the length of time that certain content is displayed by the RDUs.

24. The method of claim 21, wherein modifying content, data and media displayed by and delivered to the RDUs further comprises modifying the location on the screen layout that particular content is displayed.

25. The method of claim 20, wherein the method of acquiring information about activity related to RDUs further comprises interacting with user electronic devices.

26. The method of claim 25, wherein interacting with user electronic devices further comprises updating the experience on the user's electronic device.

27. The method of claim 20, wherein determining available data sources from which the RDUs can acquire data further comprises acquiring data from a data unit.

28. The method of claim 27, wherein acquiring data from a data unit further comprises acquiring data from local users or local locations.

29. The method of claim 28, wherein the local locations comprise individuals or groups interacting with the RDUs, wherein the groups interacting with the RDUs can further comprise local vendors that transmit product, customers, or transaction information to the RDUs.

30. The method of claim 28, wherein the local users and the local locations communicate with the RDUs through a local network.

31. The method of claim 27, wherein acquiring data from a data unit further comprises acquiring data from remote users or remote locations.

32. The method of claim 31, wherein acquiring data from the remote users or the remote locations further comprises providing the data from the remote users or remote servers to a data unit via a remote data unit server.

33. The method of claim 31, wherein acquiring data from the remote users or the remote locations further comprises providing the data utilizing one or more data units dispersed in different geographic locations.

34. The method of claim 31, wherein acquiring data from the remote users or the remote locations further comprises providing the data over a network.

35. The method of claim 31, providing the data from the remote users or remote servers via a remote data unit server further comprises transmitting the data to a data unit over a network.

36. The method of claim 27, wherein acquiring data from a data unit further comprises providing a passive data acquisition system.

37. The method of claim 27, wherein acquiring data from a data unit further comprises providing an active data acquisition system.

38. The method of claim 27, wherein acquiring data from a data unit further comprises providing a data unit comprising a device for interacting with wireless user electronic devices.

39. The method of claim 27, wherein the data unit communicates via a wired connection with user electronic devices.

40. The method of claim 20, wherein selecting the appropriate data algorithm to process the data and content further comprises using the data source determined to be available.

41. The method of claim 20, wherein the method of acquiring information about activity related to RDUs further comprises using the obtained data to analyze the effect of content displayed by the RDUs.

42. The method of claim 41, wherein using the obtained data to analyze the effect of content displayed by the RDUs ruther comprises determining the efficiency of an advertisement.

43. The method of claim 20, wherein the method of acquiring information about activity related to RDUs further comprises storing the information for later analysis.

44. The method of claim 20, wherein selecting the appropriate data algorithm to process the information about activity related to RDUs further comprises indicating which information obtained from the data sources is to be utilized, how that data is processed, and how that data can be stored.

45. The method of claim 20, obtaining the information about activity related to RDUs further comprises obtaining behavioral data.

46. The method of claim 20, obtaining the information about activity related to RDUs further comprises obtaining demographic information.

47. The method of claim 45 or claim 46, wherein obtaining behavioral data or demographic information further comprises interacting with users to obtain the behavioral data or the demographic information.
